(19) United States
(12) Patent Application Publication
(10) Pub. No.: US 2020/0273338 A1
(43) Pub. Date: Aug. 27, 2020

(54) MUNICIPAL PARKING SPACE RESERVATION

(71) Applicant: Miriam Srebnogur, Jerusalem (IL)

(72) Inventor: Miriam Srebnogur, Jerusalem (IL)

(21) Appl. No.: 16/288,135

(22) Filed: Feb. 28, 2019

(30) Foreign Application Priority Data
Feb. 27, 2019 (IL) 265083

(51) Int. Cl. G08G 1/14

(52) U.S. Cl. CPC G08G 1/148; G08G 1/065; G08G 1/141

(57) ABSTRACT

An aspect of some embodiments of the current invention relates to a system for temporarily reserving parking spaces in a public lot. Optionally, the lot will be divided between spaces that are open for anyone and spaces that are reserved. For example, there may be a barrier between reserved and unreserved areas of the lot. Optionally, the barrier may be movable. In some embodiments, individual spaces are reserved. Alternatively or additionally, the number vehicles in the lot is limited, but the spaces are undifferentiated. Optionally, the price of parking may depend on the location in the parking lot, the time and/or the reservation.

### FIELD AND BACKGROUND OF THE INVENTION

The present invention, in some embodiments thereof, relates to a method and system of facilitating parking and more particularly, but not exclusively, to a system for reserving parking spaces in a public lot. In some embodiments, a parking system reduces congestion in and/or increases revenue is urban areas.

U.S. Pat. No. 9,734,710 appears to disclose, “a real-time traffic flow control and dynamic route guidance system, a parking guidance system using the same, and a method thereof capable of guiding a vehicle distribution and a transportation flow by collecting positional information, destination information, a vehicle moving speed, and the like from each vehicle in real time at one or a plurality of central centers by using an in-vehicle navigator with bidirectional communication and a GPS to dynamically calculate and provide an optimal route of an individual vehicle so as to make a flow of the entire transportation network smooth and perform a control for a transportation network structure through various kinds of traffic control devices installed on roads.”

U.S. Pat. No. 8,589,065 seems to disclose that, “Among other things, one or more techniques and/or systems for parking-based route navigation and/or parking resource management are disclosed to facilitate navigation to parking spots associated with a destination and/or management of respective parking spots. Navigation may be provided to a parking spot based upon parking criteria (e.g., such as distance to a destination and/or costs associated with the parking spot). Additionally, navigation (e.g., instructions, alternate transport, such as public transit) from the parking spot to the destination may be provided. Parking spots may be reserved by a parking management system based upon reservations received through a parking-based route navigation system. Travelers may be re-routed based upon parking factors (e.g., traffic around a parking location, parking density, etc.). Accordingly, travelers may be routed to a destination in a more efficient manner and/or a management system may price and/or allocate parking spots in a desired manner.”

Chinese Published Patent Application no. CN103456184 appears to disclose, “a parking billing navigation system. The parking billing navigation system comprises a vehicle-mounted terminal and a parking management module. The vehicle-mounted terminal obtains and identifies the identity of a user, the parking management module collects parking space information in a booked area and traffic flow information of a road, the vehicle-mounted terminal receives the parking space information to allow the user to book a needed parking space and then transmits the booked parking space of the user to the parking management module, the parking management module receives the booked parking space of the user and then locks the booked parking space according to the identity and the booked parking space of the user, the position of the user is obtained, a parking line with little traffic flow and without traffic jam is recommended to the user according to the traffic flow of the road between the booked parking space and the position of the user, billing is started after the parking space is booked by the user, and fee deduction is carried out when the user completes parking and leaves the parking space. By means of the parking billing navigation system, user parking is tremendously facilitated, user parking time is greatly saved, parking efficiency is enormously improved, the problem that user parking is difficult is solved, and urban traffic congestion is relieved.”

Additional background art includes Chinese Published Patent Application no. CN104851318 and Japanese Published Patent Application no. JP2003109195.

### SUMMARY

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

According to an aspect of some embodiments of the invention, there is provided a system for allocating reserved parking spaces including: a first space for reserved parking; a second space for unreserved parking; and a server configured for tracking an availability of parking, and assigning reserved parking spaces.

According to some embodiments of the invention, the server is further configured to reassign the second space to an additionally reserved space.

According to some embodiments of the invention, the system further includes a moveable barrier having a first position separating the reserved space from the first space and a second position which does not separate the first space from the second space.

According to some embodiments of the invention, reserved first space includes a first entrance having an identification device to identify a user entering the first entrance.

According to some embodiments of the invention, the second space includes a second entrance.

According to some embodiments of the invention, reserved first space includes a first exit having an identification device to identify a user exiting the first exit.

According to some embodiments of the invention, the second space includes a second exit.

According to an aspect of some embodiments of the invention, there is provided a method for allocating reserved parking spaces including: receiving over a network a request from a user for a reserved space at a reserved time; further receiving identifying information about the user over the network; assigning a parking space to the user according to his request; preventing another user from parking in the reserved space; permitting the user to enter the reserved space at the reserved time.

According to some embodiments of the invention, the preventing includes preventing the another user from entering an entrance to a reserved part of a parking lot.

According to some embodiments of the invention, the permitting includes identifying the user and allowing him to enter the entrance.

According to some embodiments of the invention, the identifying is via the identifying information.

According to some embodiments of the invention, there is a first section of reserved spaces and a second section of non-reserved spaces and where the assigning is from the first section; the method further including: changing a space from the first section to the second section.

According to some embodiments of the invention, the changing includes moving a barrier separating the first section from the second section.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 is flow chart illustrating a method of reserving a space in accordance with an embodiment of the current invention;

FIG. 2 illustrates a method of organizing parking in a lot having an adjustable size;

FIGS. 3 and 4 are block diagrams of a parking lot in accordance with embodiments of the current invention;

FIGS. 5 and 6 are schematic illustrations of a parking lot in accordance with some embodiments of the current invention; and

FIG. 7 is a schematic illustration of a parking reservation system in accordance with some embodiments of the current invention.

### DESCRIPTION OF SPECIFIC EMBODIMENTS OF THE INVENTION

The present invention, in some embodiments thereof, relates to a method and system of facilitating parking and more particularly, but not exclusively, to a system for reserving parking spaces in a public lot. In some embodiments, a parking system reduces congestion in and/or increases revenue is urban areas.

Overview

An aspect of some embodiments of the current invention relates to a system for temporarily reserving parking spaces in a public lot. Optionally, the lot will be divided between spaces that are open for anyone and spaces that are reserved. For example, there may be a barrier between reserved and unreserved areas of the lot. Optionally, the barrier may be movable. In some embodiments, individual spaces are reserved. Alternatively or additionally, the number vehicles in the lot is limited, but the spaces are undifferentiated. Optionally, the price of parking may depend on the location in the parking lot, the time and/or the reservation.

Specific Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

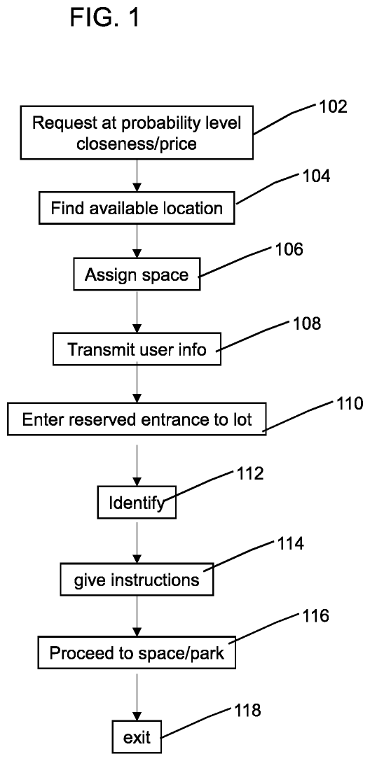

Referring now to the drawings, FIG. 1 is flow chart illustrating a method of reserving a space in accordance with an embodiment of the current invention. A user employs a network capable communication device (e.g. a smartphone, a personal computer PC) to communicate a request 102 for a parking space to a municipality. For example, the communication device may include a navigation application that requests 102 parking near a desired target location and/or at a predicted arrival time. Alternatively or additionally, the application may reserve a space at a desired arrival time (for example, if the user needs to arrive at a doctor's appointment at 12:30 on Wed., he may reserve a parking space near the office ahead of time for 12:15 until 2:15). Optionally, the municipality finds 104 available spaces and/or offers a space. When the space fits the criteria of the user, a credit card is optionally debited (for example for the costs of two hours parking and/or for a safety deposit) and/or a space is assigned 106 to the user. Optionally, the user's network device will transmit 108 payment information and/or user information (for example a license number) to the parking lot server. In some embodiments, when the user travels to his destination, a navigation application directs him to the space. For example, the application may guide the user to a reservation only entrance to the parking lot. Upon entrance the parking lot system checks the identity of the vehicle and/or user (for example, via reading a license plate of the vehicle and/or through communication with the network device of the user). Optionally, the system assigns 106 a parking space to the user. The user parks for the allotted time. When the user leaves the space, the system is updated and/or the space is freed for another user.

In some embodiments, when a user arrives at the parking area (e.g. when he enters 110), he will be optionally be identified 112. For example, a reader may read the license of his vehicle and/or identification 112 may be made through electronic communication for example between the parking serve and the users network device as he arrives. Optionally the user is instructed 114 where to park. For example, he may be given 114 a card with his space number and/or the space number may be sent to his network communication device. Optionally, he will reserve a space for a certain time period. The user optionally proceeds 116 to his space and/or parks. In some embodiments, a warning will be sent to the user (for example a text message to his network device) when the parking time is ended and/or some time before hand. Optionally if his stay extends beyond expectations, he will be able to extend his reservation (for example using his network device before the end of his reservation and/or the extension may be made automatically when his car is not detected existing the parking lot). In accordance with the reservation, the user may leave his car in the space beyond the originally specified time. For example, a lot may have a number reservable spaces. When the number of reservations is not beyond the number of locations, extension will be accepted. Optionally a certain number of spaces will be held in reserve for people who do not leave on time and/or when all available spaces are already booked. When all available spaces are already booked extensions and/or further reservations may not be accepted. Optionally contingent extensions and/or reservations may be accepted (for example, a reservation may be accepted based on a certain probability that the space will become free).

In some embodiments, a user may be charged for the entire reserved parking time. For example, the user may be charged for the full price of parking at the time of reservation without refunds. Optionally, extensions of time will be charged a different fee from the original reservation. In the case that a user does not show up and/or cancels he may be charged a cancellation fee, but not the entire parking fee. In some embodiments, a user who leaves early may receive a refund of part of the costs.

In some embodiments a fixed space may be reserved for fixed time. For example, when a user reserves a space, he will be assigned 106 a particular space which will not be available for anyone else. A user who does not exit 118 his space in time may be fined and/or towed. Alternatively or additionally, a certain time may be set between consecutive reservations for example, to avoid a user arriving and finding a previous user occupying his space. Optionally, there may be extra spaces for users with reservations, whose space are not available.

In some embodiments, a parking lot may have an area where reserved and unreserved parking are mixed. For example, the parking system may count the number of people entering and existing. Unreserved parkers may be allowed only as long as enough reserved places remains free. Optionally, at a certain lead time period before a reservation, if there are no extra empty space (e.g. if there are no empty space and/or are only enough spaces for the already existing reservation), the lot may allow unreserved parkers to enter. The amount of lead time may be fixed and/or may be adjusted according the probably of an occupant leaving at a given time. When a user comes with a reservation he may be allowed in and enter 110 and/or proceed 116 to search for the empty space. Alternatively or additionally, the system may track individual vehicles and/or individual spaces and assign 106 a space to a parker (whether or not he has a reservation) upon entrance to the lot. Optionally, there may be different price for occupancy of a space when there was a reservation and/or without reservation.

In some embodiments, a system may include a license plate reader. When a user makes a reservation, he may transmit 108 his license plate number to the server. When he enters 110 at the entrance, he may be allowed to enter and/or assigned 106 a place according to his license. Optionally, when a user exits 118, the system will read his license plate and/or update the availability of his space automatically. In some embodiments, there may be periodical checking of occupancy (for example a person and/or a robot may travel around the lot and/or record (e.g. make images of) free and/or occupied spaces and/or a server database may be updated accordingly. If a user parked in the wrong space, the system is optionally updated to reflect the true status of the spaces. Optionally, the location of a car will be registered by locating his network communication device at the time of parking and/or a user will report where he parked for example at a ticket machine and/or by taking an image of a space identifier with his network communication device and transmitting 108 it to a parking lot management server.

In some embodiments, payment may be arranged by the communication device, for example using a credit card account and/or an account with the parking provider. Alternatively or additionally, payment may be through pay stations and/or a local network of the parking lot.

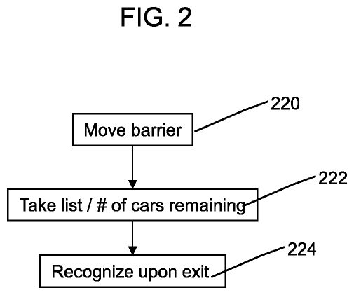

FIG. 2 illustrates a method of organizing parking in a lot having an adjustable size. For example, a lot may have a first section with reserved parking and/or second section with unreserved parking and/or a movable 220 barrier. between the first and second section. For example, at a certain time of day the barrier may be moved 220. Cars having no reservation and/or remain in the area added to the reserved section past the fixed time may be fined and/or towed. In some embodiments the barrier may be moved 220 at unscheduled times, for example dependent on the number of reservations and/or occupancy of the spaces. Additionally or alternatively, there may be a separate entrance and/or exit for the reserved and/or unreserved sections. In some embodiments, upon exit 224 it may be calculated how much time a car spent in a reserved and/or unreserved area (for example, based on the time and/or place of entrance and/or exit). In some embodiments, when division between reserved and unreserved portion of a lot is moved 220 a list 222 may be made of remaining cars. For example, a car that had a reservation from an early time will be charged a reserved place for the reserved time. A car that parked in an area that was not reserved may be charged the unreserved price up to the time of the moving of the barrier and/or the reserved price after that time.

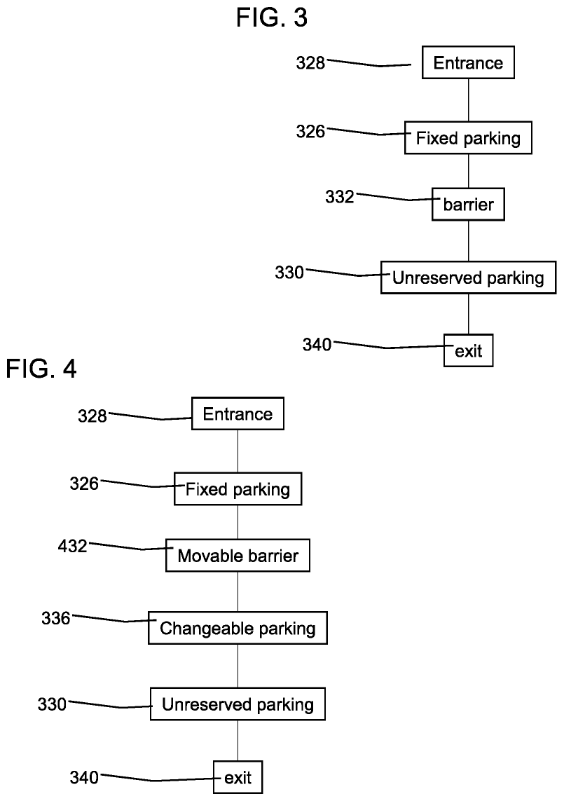

FIGS. 3 and 4 are block diagrams of a parking lot in accordance with embodiments of the current invention. In some embodiments, a parking lot may have a fixed area 326 for reserved parking. For example, parking in the fixed area 326 may be by pre-reserved places. A user may pre-reserve a specific place for a specific time. When he arrives at the lot entrance 328, he and/or his car may be recognized by an identification device (e.g. a license plate reader and/or a device communicating with the communication device of the user). Optionally, cars are only allowed in at their reserved times. Optionally, the user may be charged from his reservation whether he uses it or not. Alternatively or additionally, a user may be refunded all or part of a parking fee depending on how much time he used and/or how long before vacating the space he gave notification. If a user does not leave the parking lot on time (for example as registered by an identification device at the exit 340) he may be given a ticket and/or charged a fine. Alternatively or additionally, his car may be ticketed or towed without warning and/or when it is blocking another user having a reservation for the space. Optionally the lot may include a separate section for unreserved 330 parking. In some embodiments a certain number of spaces may be held in reserve for users with reservation whose spaces are occupied (for example by drivers who did not vacate their spaces on time. A barrier 332 optionally separates between the reserved and/or unreserved sections. Optionally a barrier 432 may be movable. For example, a portion 336 of the lot may change between reserved and/or unreserved status.

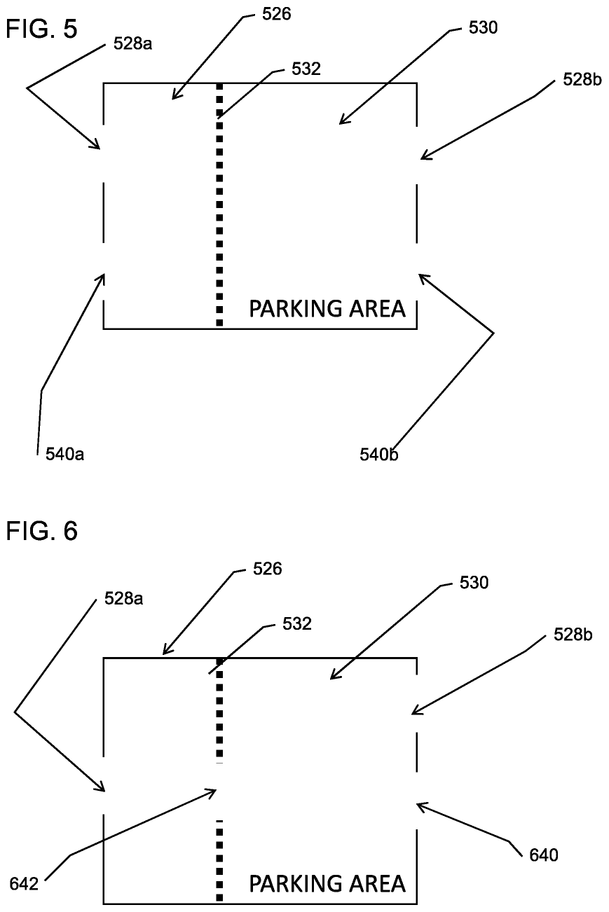

FIGS. 5 and 6 are schematic illustrations of a parking lot in accordance with some embodiments of the current invention. In some embodiments, a lot may have reserved 526 and/or unreserved 530 sections. Optionally, a reserved 526 and/or unreserved 530 portion of the lot may have separate entrances 528a, 528b and/or exits 540a, 540b (for example as illustrated in FIG. 5). Alternatively or additionally, the reserved 526 and unreserved 530 areas may share an exit 640, but have separate entrances 528a, 528b (for example the barrier 532 may block cars from entering the reserved area from the unreserved area but have an opening 642 to allow cars from the reserved area 526 to exit via the unreserved area 530 for example as illustrated in FIG. 6). Alternatively or additionally, there may be a shared entrance but separate exits. Alternatively or additionally, the sections may be mixed, for example with control over the number of parkers and/or locations of parking for example as described herein above. Alternatively or additionally, an entire lot may be reserved.

In some embodiments a lot may have a movable barrier. For example, management strategy for some barriers in accordance with some embodiments are illustrated in FIGS. 4, 5, 6 and/or FIG. 1 and its description.

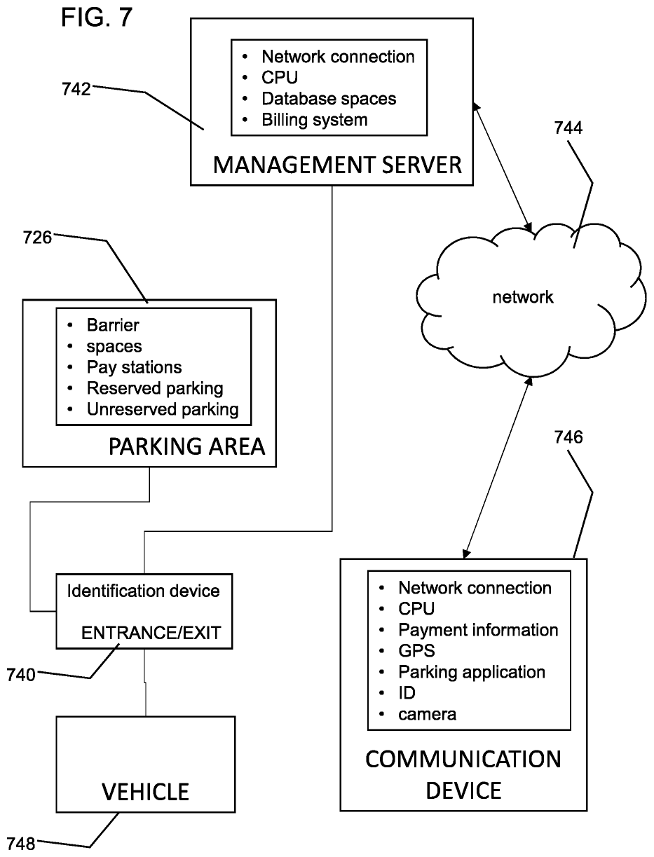

FIG. 7 is a schematic illustration of a parking reservation system in accordance with some embodiments of the current invention. In some embodiments, a user makes a reservation for a parking space using a network communication device 746. For example, the device 746 may be a smart phone. Optionally, the device 746 includes a network connection and/or a processor and/or a secure payment system (for example, a password protected payment system and/or a biometric protected payment system). Optionally the device 746 includes a location sensor (e.g. a GPS sensor and or navigation capabilities [for example including an accelerometer, a gyro and/or a navigation application]). For example, a navigation application may be integrated with a parking finder application for example to give estimated time of arrival to a parking and/or make reservations accordingly and/or to direct a user to a parking space. Optionally a user will use the network device 746 to reserve a parking place and/or to report a space where a vehicle 748 is parked (for example based on location and/or by sensing a space indicator, by photographing a space marker and/or sending the photo and/or the indication to a management server 742 of the parking lot) in a parking area 726.

In some embodiments a parking area 726 will be associated with a management server 742. For example, the management server 742 may receive reservations and/or payment over a network 744 (e.g. from a network communication device 746). The server 742 may optionally assign and/or track the availability of spaces. In some embodiments, the server 742 will include a network adapter and/of a processor and/or memory (for example storing a database of parking spaces reservations and/or availability).

In some embodiments, a parking area may include an entrance and/or an exit. For example, an entrance and/or exit may include an identification device (for example a license plate reader) to identify a vehicle 748 entering and/or exiting the parking area 726. Optionally and identification device is connected to the management server 742 and/or reports to the server 742 the identity of vehicles 748 entering and/or exiting. The connection may be, for example, over a hard-wired connection, a local network and/or a public network 744. In some embodiments, an entrance and/or exit barrier will block unauthorized passage. Optionally there may be a barrier between sections of a parking area 726. For example, there may be an unreserved section and a reserved section. In some embodiments, there may be a barrier between sections. Optionally, the barrier may be movable (e.g. to change the number of spaces in the sections). Alternatively or additionally, divisions may be fixed. Alternatively or additionally, a parking area 726 may be undivided. Alternatively or additionally, a system in accordance with the current invention may control reserved parking in an uncontrolled area 726 and/or on street side parking. In some embodiments, a parking area 726 may include one or more pay stations. Alternatively or additionally, payment may be over a network 744, for example by credit card and/or by prepayment and/or by automatic bank payment. In some embodiments, a parking area 726 will include one or more entrances and/or exits 740. An entrance and/or exit 740 optionally includes an identification device. For example, the identification device may include a license reader and/or a RFID reader and/or a wireless receiver and/or beacon etc.

General

It is expected that during the life of a patent maturing from this application many relevant building technologies, artificial intelligence methodologies, computer user interfaces, image capture devices will be developed and the scope of the terms for design elements, analysis routines, user devices is intended to include all such new technologies a priori.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

As used herein the term “about” refers to ±20%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for allocating reserved parking spaces comprising:
a first space for reserved parking;
a second space for unreserved parking;
and a server configured for
tracking an availability of parking,
and assigning reserved parking spaces.

2. The system of claim 1, wherein said server is further configured to reassign said second space to an additionally reserved space.

3. The system of claim 2, further including a moveable barrier having
a first position separating said reserved space from said first space and
a second position which does not separate said first space from said second space.

4. The system of claim 1, wherein reserved first space includes a first entrance having an identification device to identify a user entering said first entrance.

5. The system claim 4, wherein said second space includes a second entrance.

6. The system of claim 1, wherein reserved first space includes a first exit having an identification device to identify a user exiting said first exit.

7. The system of claim 6, wherein said second space includes a second exit.

8. A method for allocating reserved parking spaces comprising:
receiving over a network a request from a user for a reserved space at a reserved time;
further receiving identifying information about said user over said network;
assigning a parking space to the user according to his request;
preventing another user from parking in said reserved space;
permitting said user to enter said reserved space at said reserved time.

9. The method of claim 8; wherein said preventing includes preventing said another user from entering an entrance to a reserved part of a parking lot.

10. The method of claim 9; wherein said permitting includes identifying said user and allowing him to enter said entrance.

11. The method of claim 9, wherein said identifying is via said identifying information.

12. The method of claim 8, wherein there is a first section of reserved spaces and a second section of non-reserved spaces and where said assigning is from said first section; the method further comprising:
changing a space from said first section to said second section.

13. The method of claim 12, wherein said changing includes moving a barrier separating said first section from said second section.
